(19) United States
(12) Patent Application Publication
(10) Pub. No.: US 2010/0083705 A1
(43) Pub. Date: Apr. 8, 2010

(54) METHOD FOR MANUFACTURING DECORATIVE FLAT GLASS USING HORIZONTAL TEMPERING FURNACE

(75) Inventor: Jae Seok Jeon, Daegu (KR)

Correspondence Address: Jefferson IP Law, LLP, 1130 Connecticut Ave., NW, Suite 420, Washington, DC, 20036, US

(73) Assignee: SAM SUNG GLASS IND. CO., LTD., Yeongcheon-si, Gyeongsangbuk-do (KR)

(21) Appl. No.: 12/596,386

(22) PCT Filed: Aug. 1, 2007
(86) PCT No.: PCT/KR07/03707

§ 371 Date: Oct. 16, 2009

(30) Foreign Application Priority Data
May 2, 2007 (KR) 10-2007-0042768

(51) Int. Cl. C03C 17/06; C03C 17/02

(52) U.S. Cl. 65/60.53; 65/60.1

(57) ABSTRACT

Provided is a method for manufacturing a decorative plate glass using a horizontal tempering furnace including, attaching crystal ice onto a surface of a plate glass, and subjecting the plate glass to a rapid heating and quenching treatment using a horizontal tempering furnace, the method further including: providing crystal ice whose constituent components are regulated such that a melting point temperature of the crystal ice is formed within the set range of the melting point temperature of the crystal ice defined as a toughening temperature of a pane core to 1O0 C above; attaching the crystal ice onto a surface of the plate glass, and rapidly heating the plate glass at a heating temperature inside the horizontal tempering furnace that corresponds to the set range of the melting point temperature of the crystal ice in the horizontal tempering furnace, wherein the rapid heating is performed by controlling a heating time using a first control factor which is readily set with respect to a heating time at the toughening temperature of a float glass; and rapidly cooling the crystal-ice-melt-attached plate glass by controlling cooling conditions using a second control factor which is readily set corresponding to the cooling conditions for toughening the float glass after the rapid heating.

### TECHNICAL FIELD

The present invention relates to a method for manufacturing a plate glass, and more particularly to a method for manufacturing a decorative plate glass in which crystal ice is melted and attached to the plate glass.

### BACKGROUND ART

Crystal ice, so called clinker enamel, is melt-stuck to a plate glass to form a pattern with various forms and shapes, thereby producing a decorative plate glass in a stylish atmosphere.

Examples of techniques on a manufacturing method of a decorative plate glass using crystal ice include Korean Patent No. 73340, “Process for the Preparation of Ornamental Glass”, Korean Patent No. 121311, “Method of Decorating Glass”, Korean Patent No. 85701, “Process for the Preparation of Ornamental Glass”, Korean Patent No. 295234, “Method for Manufacturing Decorative Plate Glass”, and Korean Patent No. 310386, “Manufacturing Process of Plate-Glass for Decoration by using Transfer Paper”, and the like.

The process for manufacturing a decorative plate glass using crystal ice comprises largely four steps.

First, in step 1, forming a pattern design on the surface of a plate glass where crystal ice is to be positioned, then in step 2, applying an adhesive agent along the pattern design on the surface of the plate glass, subsequently in step 3 spraying the crystal ice onto the adhesive agent, and lastly in step 4, attaching the crystal ice on the plate glass through a heating and cooling process so as to complete a decorative plate glass.

As a method of heating and cooling in the manufacturing process for a decorative plate glass, mention can be made of slow heating and slow cooling, and rapid heating and quenching. Before the publication of the above-mentioned Korean Patent No. 295234, “Method for Manufacturing Decorative Plate Glass”, slow heating and slow cooling was employed in manufacturing the decorative plate glass.

However, such slow heating and slow cooling generated cracks in the surface of the crystal ice, which affected even the mother-body, which is a plate glass, thereby disadvantageously weakening the strength of the decorative plate glass.

Moreover, such slow heating and slow cooling generally has literally a longer heating time and longer cooling time. Specifically, the heating time and the cooling time in slow heating and slow cooling varies to some extent depending on a thickness or size of a plate glass, a performance of a furnace, or the like. When the target heating temperature is set at about 600° C., the time for elevating the temperature in the furnace to the target heating temperature of 600° C. is about 40 to 50 minutes. Meanwhile, the time for cooling the temperature in the furnace, whose temperature reached the target heating temperature of about 600° C., to the handleable temperature of 60 to 70° C. is about 1 hour to 2 hours.

The above-mentioned Korean Patent No. 295234, “Method for Manufacturing Decorative Plate Glass”, which has outgrown from the conventional slow heating and slow cooling, is a Grant Patent by the inventor and applicant of “Jeon Jae Seok” who is the inventor of the present invention. There is a big significance in the above Patent in that a rapid heating and quenching is employed and applied to the heating and cooling method for the first time in the process of manufacturing a decorative plate glass. Additionally, there is a bigger significance in that by using a horizontal tempering furnace, a decorative plate glass having excellent product value can be mass-produced.

In Korean Patent No. 295234, upon employing the rapid heating and quenching method, various kinds of furnaces such as an automatic horizontal tempering furnace, a semiautomatic vertical tempering furnace, or a typical furnace was utilized to carry out the experiment. Among these, it is confirmed that a method for manufacturing a decorative plate glass using the automatic horizontal tempering furnace is most preferable. When manufacturing a decorative plate glass using the horizontal tempering furnace, the pattern deformity in the crystal ice, which is melted on the plate glass, by the rapid heating, is prevented. Further, in order to preserve the pattern formed on the plate glass to have a transparent and beautiful pattern, like vapordrops, it is very important to maintain the air supply line in a closed state, and to transfer the plate glass into the cooling device for quenching when the crystal ice reaches the melting point temperature by the rapid heating. When the air supply line of the horizontal tempering furnace is closed, the crystal ice in the horizontal tempering furnace is not affected by the airflow. Thus, the pattern deformity in the crystal ice can be prevented in advance. Moreover, when the quenching is carried out at the melting point temperature of the crystal ice, the crystal ice forms transparent droplets, like vapordrops, and they are solidified.

In a decorative plate glass, an appearance that expresses the glass is considered important, and, particularly, the decoration pattern of crystal ice serves as an important criterion to determine the quality of the product.

Therefore, in manufacturing a decorative plate glass using a horizontal tempering furnace, not having the airflow in the horizontal tempering furnace can be achieved through mechanical or chemical control. However, finding the melting peak point temperature of crystal ice is achieved by relying on a skilled technician with production experience in the decorative plate glass field over a long period of time.

Recently, the types of horizontal tempering furnaces are varied, such as an electrically heated radiation furnace, a gas heated convection furnace or a forced convection-heating furnace, and they tend to increase gradually. Further, the performances of horizontal tempering furnaces themselves are also improving gradually. Moreover, even in one type of horizontal tempering furnace, the size may vary. Even with the same size, the structure and performance may differ depending on the production company. Additionally, the types of crystal ice are also varied.

As a result, it is not easy for a technician to find the melting peak point temperature and perform a rapid heating and quenching treatment by using a horizontal tempering furnace for the production of a decorative plate glass through accumulating one's experience.

Nonetheless, the horizontal tempering furnace is produced to meet the purpose of the glass reinforcement in addition to manufacturing the decorative plate glass. Thus, an operation of the expensive horizontal tempering furnace equivalent to several billion dollars at the discretion for accumulating experiences for manufacturing the decorative plate glass could break the horizontal tempering furnace.

### DISCLOSURE OF INVENTION

### Technical Problem

Outgrown from producing a decorative plate glass product via trial and error, a person with skills in the art to easily perform the treatment of rapid heating and quenching using a horizontal tempering furnace is in demand.

Therefore, the present invention has been made in view of the above problems, and it is an object of the present invention to provide a method for manufacturing a decorative plate glass capable of even more easily performing rapid heating and quenching treatment in manufacturing of a decorative plate glass in which crystal ice is melt-attached to the plate glass using a horizontal tempering furnace.

It is another object of the present invention to provide a method for manufacturing a decorative plate glass capable of finding the exact melting peak point temperature of crystal ice depending on a type of a horizontal tempering furnace, thickness of a plate glass, and type of crystal ice.

### Technical Solution

In accordance with an aspect of the present invention, the above and other objects can be accomplished by the provision of a method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising: providing crystal ice whose constituent components are regulated such that a melting point temperature of the crystal ice is formed within the set range of the melting point temperature of the crystal ice defined as a toughening temperature of a pane core to 10° C. above; attaching the crystal ice onto a surface of the plate glass, and rapidly heating the plate glass at a heating temperature inside the horizontal tempering furnace that corresponds to the set range of the melting point temperature of the crystal ice in the horizontal tempering furnace, wherein the rapid heating is performed by controlling a heating time using a first control factor which is readily set with respect to a heating time at the toughening temperature of a float glass; and rapidly cooling the crystal-ice-melt-attached plate glass by controlling cooling conditions using a second control factor which is readily set corresponding to the cooling conditions for toughening the float glass after the rapid heating.

In accordance with another aspect of the present invention, there is provided a method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising: providing lead-free crystal ice whose constituent components are regulated such that a melting point temperature of the lead-free crystal ice is formed within the set range of the melting point temperature of the lead-free crystal ice defined as a toughening temperature of a pane core to 10° C. above; attaching the lead-free crystal ice onto a surface of the plate glass, and rapidly heating the plate glass at a heating temperature inside the horizontal tempering furnace that corresponds to the set range of the melting point temperature of the lead-free crystal ice in the horizontal tempering furnace, wherein the rapid heating is performed by controlling a heating time such that the heating time is 10 to 15% longer than a heating time to the toughening temperature of a float glass; and rapidly cooling the lead-free crystal-ice-melt-attached plate glass by controlling cooling conditions using a control factor which is readily set corresponding to the cooling conditions for toughening the float glass after the rapid heating.

In accordance with yet another aspect of the present invention, there is provided a method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising: providing lead crystal ice whose constituent components are regulated such that a melting point temperature of the lead crystal ice is formed within the set range of the melting point temperature of the lead crystal ice defined as a toughening temperature of a pane core to 10° C. above; attaching the lead crystal ice onto a surface of the plate glass, and rapidly heating the plate glass at a heating temperature inside the horizontal tempering furnace that corresponds to the set range of the melting point temperature of the lead crystal ice in the horizontal tempering furnace, wherein the rapid heating is performed by controlling a heating time such that the heating time is 0 to 10% longer than a heating time to the toughening temperature of a float glass; and rapidly cooling the lead crystal-ice-melt-attached plate glass by controlling cooling conditions using a control factor which is readily set corresponding to the cooling conditions for toughening the float glass after the rapid heating.

In the present specification, “horizontal tempering furnace” is a generic term for heating furnaces that puts the plate glass into the furnace in a horizontal manner.

### Advantageous Effects

In manufacturing a decorative plate glass in which crystal ice is melt attached to a plate glass using a horizontal tempering furnace, the present invention can perform a rapid heating and quenching treatment more easily using a horizontal tempering furnace by applying a relative ratio with respect to the heating and cooling conditions of the rapid heating and quenching for toughening the conventional float glass. In addition, a melting peak point temperature of crystal ice can be obtained almost accurately according to a type of a horizontal tempering furnace, thickness of a plate glass, and type of crystal ice through trials.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a phase diagram illustrating the melting peak point temperature in manufacturing a decorative plate glass using a horizontal tempering furnace; and

FIGS. 2 to 5 are heating curves in relation to plate glasses put into a horizontal tempering furnace according to the embodiments of the present invention.

### BEST MODE FOR CARRYING OUT THE INVENTION

The present invention will now be described in greater detail with reference to the accompanying drawings.

In an embodiment of the present invention, a decorative plate glass is manufactured having crystal ice melt-attached on the plate using a horizontal tempering furnace. Among horizontal tempering furnaces, an electrically heated horizontal tempering furnace is preferably used. The electrically heated horizontal tempering furnace is advantageous in that airflow is not formed in the horizontal tempering furnace in manufacturing the decorative plate glass using a horizontal tempering furnace.

The horizontal tempering furnace used in the present invention comprises largely a heating furnace and a cooling device. A detector for detecting an atmospheric temperature (hereinafter, referred to as “temperature inside of a heating furnace”) in the heating furnace is installed in the heating furnace. A technician can set a desired heating temperature inside the horizontal tempering furnace by using the external operating panel, which is electrically connected to a control part of the horizontal tempering furnace. Basically a set heating temperature for toughening the plate glass in the horizontal tempering furnace is usually given by the manufacturer as a default or noted in a manual.

Manufacture of a decorative plate glass using a horizontal tempering furnace in the present invention employs a rapid heating and quenching method, thereby allowing a mass-production of the decorative plate glass. When manufacturing a decorative plate glass having crystal ice melt-attached to the plate glass using the horizontal tempering furnace, the melting peak point temperature of the crystal ice functions as an important factor.

The melting peak point temperature of crystal ice refers to a temperature at which the crystal ice in a powdered form is heated into a liquid form. The liquefied crystal ice develops surface tension and pulls on itself to cohere together into a transparent droplet shape, like vapordrops.

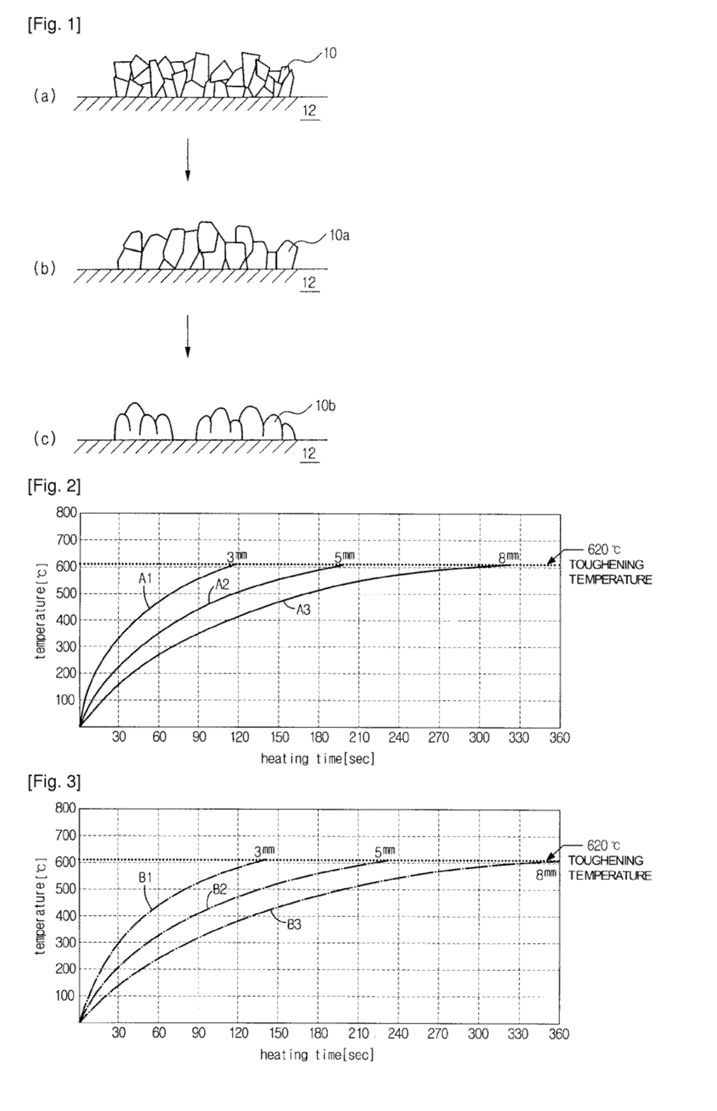

Referring to FIG. 1, crystal ice in a solid powder form with a size of sugar is not slowly melted. As shown in FIG. 1a, crystal ice powder 10 on a plate glass 12 maintains its solid form for a prolonged time, even with the continuous heating. Then, the crystal powder 10 is suddenly melted into droplets of liquid 10a. Thereafter, the droplets of liquid 10a develop surface tension and pull on themselves to form transparent coherent droplets 10b, like vapordrops. Such a coherent state of crystal ice is called “melting peak point temperature”.

The time consumed from the point where crystal ice changes from a solid state into a liquid state to the point until the liquid state begins to form coherent droplets is defined as “time to reach melting peak point temperature”. According to the researches conducted by the inventor of the present invention, the time to reach melting peak point temperature is a very short period of time, i.e., 10 to 20 seconds, although there is a slight variation depending on the amount of crystal ice sprayed onto a plate glass.

The coherent state of crystal ice at the melting peak point temperature having a transparent droplet form like vapordrops, is not continuously preserved. As time passes from the time to reach the melting peak point temperature, for example, about 30 seconds, the coherent liquid state crystal ice, like vapordrops, slowly spreads out in the sidewise direction. Therefore, the manufacturer of a decorative plate glass must provide a system for quickly cooling the plate glass at the melting peak point temperature.

In the specification of the present invention, the time for maintaining crystal ice in the coherent state of a transparent droplet form like vapordrops, when the crystal ice reaches the melting peak point temperature, is defined as “time for maintaining the melting peak point temperature”. The time values of the “time to reach melting peak point temperature” and “time for maintaining the melting peak point temperature” are obtained by the inventors through conducting many experiments at a laboratory or actual experiences on the production of a decorative plate glass.

In a decorative plate glass, an appearance that expresses the glass is considered very important, for the reason that the appearance serves as an important criterion to determine the productivity and the quality of the product.

Therefore, in manufacturing a decorative plate glass using a horizontal tempering furnace, in addition to the melting peak point temperature of crystal ice, the state of the plate glass to be a body plate is also very important. That is, defects such as cracks on the plate glass itself should not be generated. In the case where the body plate glass is damaged in the process of manufacturing the decorative plate glass, there is no productive value as a decorative plate glass, even though crystal ice is beautifully designed on the plate glass.

In the present invention, in order to prevent damage of the plate glass, the manufacturing of the decorative plate glass using a horizontal tempering furnace is realized at a temperature exceeding the toughening temperature of the plate glass. Moreover, it is realized such that the range of the melting point of the crystal ice is set at a temperature approximately exceeding the toughening temperature of the plate glass.

According to a literature, the toughening temperature of the plate glass is about 620° C. This fact is disclosed in a thesis, I. C. Kramer, “HORIZONTAL TOUGHENING DESIGN FEATURES CONVECTIVE HEATING”, Glass International, 1993.

According to the thesis, it states, “a softening temperature of a common plate glass is about 530° C., and a toughening temperature is about 620° C. In order to prevent deformation of the plate glass to be heated such that the plate glass put into a tempering furnace exceeds the softening temperature and reaches the toughening temperature of about 620° C., the ceramic roller must operate back and forth continuously.”

At this time, the toughening temperature of the plate glass is the temperature of the plate glass itself, instead of the temperature inside of the horizontal tempering furnace. That is, the toughening temperature of a plate glass is a temperature at the pane surface and the pane core.

The toughening temperature of the plate glass (hereinafter, referred to as “toughening temperature of a pane core”) is an independent value, instead of a value depending on the various external factors (i.e., type, size, inner temperature change, performance improvement of a horizontal tempering furnace). That is, the toughening temperature is the inherent temperature of the plate glass.

Therefore, in an embodiment of the present invention, in order to prevent damage on the body plate glass, the inherent temperature influencing the plate glass is measured directly so that the rapid heating is realized until the temperature reaches the toughening temperature of the pane core. Moreover, the melting point temperature of crystal ice is also set in a range based on the toughening temperature of a pane core.

The range of the melting point temperature of the crystal ice according to the embodiment of the present invention is preferably set in a range of the toughening temperature of a pane core to 10° C. above. That is, since the toughening temperature of a pane core is 620° C., the set range of the melting point temperature of the crystal ice according to the embodiment of the present invention is 620 to 630° C.

The set range of the melting point temperature of the crystal ice may be 630° C. or higher. However, considering the difficulties of continuously operating the ceramic roller back and forth inside the furnace so as to prevent deformation of the plate glass in the horizontal tempering furnace after passing the softening temperature, it is preferable to set the range of the melting point temperature of the crystal ice at 620 to 630° C.

In general, as crystal ice, use can be made of a well known conventional lead crystal ice. The lead crystal ice is crystal ice containing a lead component. Specifically, the lead crystal ice is crystal ice containing 75% or more of a lead (Pb) component, and 5% or more of a cadmium (Cd) component. Examples of the constituent components of the lead crystal ice include SiO₂, B₂O₃, Na₂O, ZnO, PbO, Cd, K₂O, Fe₂O₃, CaO, and Al₂O₃.

Unlike the lead crystal ice, lead-free crystal ice containing no lead (Pb) component was developed by the inventor of the present invention. There are three examples of the preferable constituent components of the lead-free crystal ice.

(1) Lead-Free Crystal Ice Constituent Components Example 1:

Na₂O, ZnO, B₂O₃, SiO₂, TiO₂, ZrO₂, Al₂O₃, K₂O, Mg, CaCO₃, Nd, and F

(2) Lead-Free Crystal Ice Constituent Components Example 2:

Na₂O, ZnO, B₂O₃, SiO₂, CaO, Al₂O₃, BaO, SrO, Li₂O₃, Fe₂O, and ZrO₂

(3) Lead-Free Crystal Ice Constituent Components Example 3:

Na₂O, ZnO, B₂O₃, SiO₂, CaO, Al₂O₃, BaO, Li₂O₃, and SrO

The melting point temperature of lead or lead-free crystal ice varies in the range of 300 to 1000° C. depending on its constituent components and composition ratios.

The inventor of the present invention found a major constituent component that determined the melting point temperature of crystal ice. By regulating the content of the constituent component, the melting point temperature of the crystal ice is included in the set melting point temperature of the crystal ice in the present invention, that is, the set range of 620 to 630° C.

In the case of lead crystal ice, the PbO (lead) component among the constituent components of the lead crystal ice in the composition ratio is preferably regulated, thereby including the melting point temperature of the crystal ice in the set melting point temperature ranging 620 to 630° C. In the case of lead-free crystal ice, the Na₂O (sodiun oxide) and B₂O₃ (boron oxide) components among the constituent components of the lead-free crystal ice in the composition ratio are preferably regulated, thereby including the melting point temperature of the crystal ice in the set melting point temperature ranging 620 to 630° C.

Particularly, in the case of lead-free crystal ice, preferable constituent components and the composition ratio thereof according to the embodiment of the present invention capable of including the melting point temperature of the crystal ice in the set range of 620 to 630° C. are exemplified in the following Tables 1 to 3.

TABLE 1

| Component | Composition (mol %) |
|---|---|
| Na₂O | 10 to 20% |
| ZnO | 10 to 30% |
| B₂O₃ | 20 to 40% |
| SiO₂ | 10 to 20% |
| TiO₂ | 0 to 5% |
| ZrO₂ | 0 to 5% |
| Al₂O₃ | 0 to 5% |
| K₂O | 3 to 10% |
| Mg | 5 to 10% |
| CaCO₃ | 3 to 10% |
| Nd | 0 to 5% |
| F | 0 to 5% |

TABLE 2

| Component | Composition (mol %) |
|---|---|
| Na₂O | 10 to 20% |
| ZnO | 0 to 10% |
| B₂O₃ | 20 to 40% |
| SiO₂ | 10 to 30% |
| CaO | 5 to 10% |
| Al₂O₃ | 0 to 5% |
| BaO | 3 to 10% |
| SrO | 0 to 5% |
| Li₂CO₃ | 0 to 5% |
| Fe₂O | 0 to 3% |
| ZrO₂ | 0 to 3% |

TABLE 3

| Component | Composition (mol %) |
|---|---|
| Na₂O | 10 to 20% |
| ZnO | 5 to 15% |
| B₂O₃ | 20 to 40% |
| SiO₂ | 10 to 30% |
| CaO | 3 to 10% |
| Al₂O₃ | 0 to 3% |
| BaO | 0 to 5% |
| Li₂CO₃ | 0 to 3% |
| SrO | 0 to 5% |

Referring to Tables 1 to 3, it is confirmed that the lead-free crystal ice utilized in the embodiment of the present invention contains B₂O₃ (boron oxide), Na₂O (sodium oxide), ZnO (zinc oxide), and CaCO₃ (calcium carbonate), instead of lead (Pb), cadmium (Cd), and lithium (Li) among the constituent components of the conventional lead crystal ice disclosed in Table 1.

The lead-free crystal ice utilized in the embodiment of the present invention has an average particle size of ø 0.2 mm to ø 1.0 mm, and an expansion coefficient of 90 to 91×10/° C. The melting point temperature of the lead-free crystal ice is in the set melting point temperature of crystal ice ranging 620 to 630° C. Therefore, the melting peak point temperature of the crystal ice is set in the range of 620 to 630° C.

When lead-free crystal ice having the above-mentioned constituent components is prepared and melt-attached on a plate glass, the crystal ice melt-attached on the surface of the plate glass is transparent and shining. Deformation and discoloration of the crystal ice did not generate in the air. Moreover, since a heavy metal is not included in the crystal ice, corrosion did not occur, and the heavy metal is not exposed to the outside of the glass surface.

It is found by the inventor that the crystal ice according to the embodiment of the present invention prepared to have the melting peak point temperature formed within the set melting point temperature of the crystal ice ranging 620 to 630° C. had the melting peak point temperature formed at the temperature of 685 to 710° C. inside of an electrically heated radiation furnace.

In order to prevent damage on the mother-body, which is a plate glass, the inventor of the present invention directly measured temperature of the plate glass itself (internal) when put into the horizontal tempering furnace. The resulting data was obtained by measuring the temperature until it reached the toughening temperature of a pane core (about 620° C.). The horizontal tempering furnace used in the experiment is an electrically heated radiation furnace. For the rapid heating, the heating temperature set in the horizontal tempering furnace is 705° C. in the horizontal tempering furnace having a size of 2.1 m×4.5 m, and 695° C. in the horizontal tempering furnace having a size of 1.8 m×2.4 m.

In order to directly measure the temperature at the plate glass itself (internal) put into the horizontal tempering furnace, the inventor of the present invention installed a plurality of non-contact infrared thermometers inside the heating furnace. The temperature values of the plate glass measured by each non-contact infrared thermometer were averaged and calculated as a resulting value of the measured temperature. For the non-contact infrared thermometer, a non-contact infrared thermometer manufactured by Raytek Corporation is used.

In the embodiment of the present invention, it is most preferable in that the non-contact infrared thermometer installed in the horizontal tempering furnace is realized such that when the measured temperature at the plate glass itself reaches the toughening temperature of the pane core, the control part of the horizontal tempering furnace considers the “time to reach the melting peak point temperature” and “time for maintaining the melting peak point temperature”, and then the operation of the horizontal tempering furnace is stopped immediately. In this case, any technician may take out the decorative plate glass immediately from the heating furnace at the melting peak point temperature of the crystal ice.

However, in practice, the non-contact infrared thermometer developed to this point, that is a thermometer capable of directly measuring the plate glass itself cannot be installed in the horizontal tempering furnace for a prolonged period of time or semi-permanently. The non-contact infrared thermometer installed in the horizontal tempering furnace functions normally in the beginning, but as time passes, the thermometer deteriorates by high temperatures inside the horizontal tempering furnace and is soon broken.

Although such a non-contact infrared thermometer cannot be installed for a prolonged time or semi-permanently, it is enough time to perform experiments while the non-contact infrared thermometer functions normally. Therefore, if various correlations are examined as the temperature of the plate glass measured by the non-contact infrared thermometer reaches 620° C., the toughening temperature of a pane core can be continuously measured indirectly through the examined correlations in approximately the same manner as measured by the non-contact infrared thermometer.

The inventor of the present invention conducted measurement on a temperature of the plate glass inside the horizontal tempering furnace using the non-contact infrared thermometer until the temperature reached 620° C. The measurements were conducted on a float glass, lead crystal ice-attached plate glass, and lead-free crystal ice-attached plate glass. Each plate glass was classified by a thickness of the plate glass and a heating time until the inherent temperature of plate glass reached the toughening temperature.

The inventor of the present invention elicited the heating curves shown in FIGS. 2 to 5 through a great amount of experiments carried out at a laboratory or a production site.

FIGS. 2 to 5 are heating curves in relation to plate glasses put into a horizontal tempering furnace according to the embodiments of the present invention. The lateral axis represents a heating time [sec] and the longitudinal axis represents a temperature [° C.].

FIG. 2 is a heating curve with respect to floating glasses having a thickness of 3 mm, 5 mm, and 8 mm in an electrically heated radiation furnace.

The heating curve of FIG. 2 according to the variation of temperatures with respect to each heating time is shown in the following Table 4.

TABLE 4

| | Time | | | | | | | | | |
|---|---|---|---|---|---|---|---|---|---|---|
| | 30 | 60 | 90 | 120 | 150 | 180 | 200 | 240 | 300 | 320 |
| Thickness | sec | sec | sec | sec | sec | sec | sec | sec | sec | sec |
| 3 mm | 330° C. | 460° C. | 560° C. | 620° C. | | | | | | |
| 5 mm | 225° C. | 360° C. | 445° C. | 510° C. | 560° C. | | 620° C. | | | |
| 8 mm | | 260° C. | | 420° C. | | 515° C. | | 580° C. | | 620° C. |

FIG. 3 is a heating curve with respect to plate glasses having a thickness of 3 mm, 5 mm, and 8 mm, whereto lead-free crystal ice having a particle size of 0.2 to 1.0 mm is applied, in an electrically heated radiation furnace.

The heating curve of FIG. 3 according to the variation of temperatures with respect to each heating time is shown in the following Table 5.

TABLE 5

| | Time | | | | | | | | | | | |
|---|---|---|---|---|---|---|---|---|---|---|---|---|
| | 30 | 60 | 90 | 120 | 140 | 150 | 180 | 200 | 225 | 240 | 300 | 360 |
| Thickness | sec | sec | sec | sec | sec | sec | sec | sec | sec | sec | sec | sec |
| 3 mm | 320° C. | 440° C. | 540° C. | 595° C. | 620° C. | | | | | | | |
| 5 mm | 215° C. | 340° C. | 420° C. | 485° C. | | 535° C. | | 595° C. | 620° C. | | | |
| 8 mm | | 250° C. | | 385° C. | | | 480° C. | | | 560° C. | 595° C. | 620° C. |

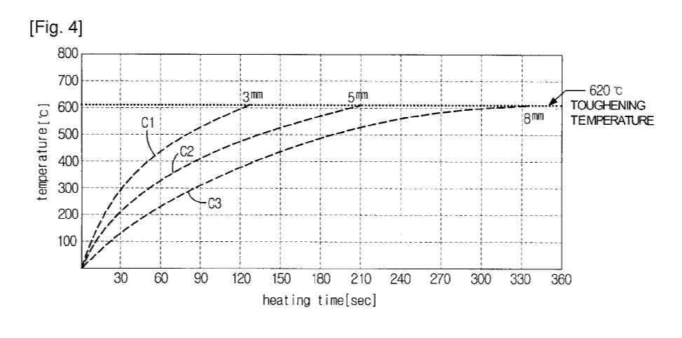

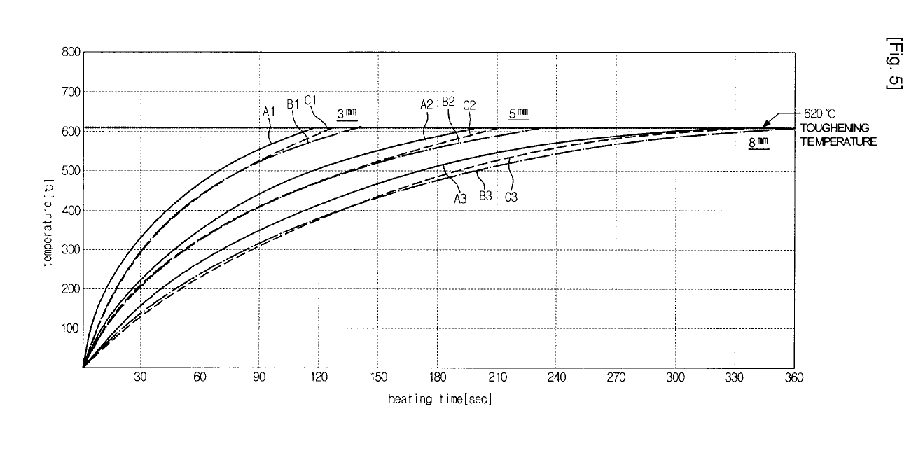

FIG. 4 is a heating curve with respect to plate glasses having a thickness of 3 mm, 5 mm, and 8 mm, whereto lead crystal ice having a particle size of 0.2 to 1.0 mm is applied, in an electrically heated radiation furnace.

The heating curve of FIG. 4 according to the variation of temperatures with respect to each heating time is shown in the following Table 6.

TABLE 6

| | Time | | | | | | | | | | | |
|---|---|---|---|---|---|---|---|---|---|---|---|---|
| | 30 | 60 | 90 | 120 | 127 | 150 | 180 | 200 | 210 | 240 | 300 | 335 |
| Thickness | sec | sec | sec | sec | sec | sec | sec | sec | sec | sec | sec | sec |
| 3 mm | 315° C. | 440° C. | 550° C. | 610° C. | 620° C. | | | | | | | |
| 5 mm | 215° C. | 340° C. | 420° C. | 485° C. | | 540° C. | | 610° C. | 620° C. | | | |
| 8 mm | | 250° C. | | 385° C. | | | 490° C. | | | 575° C. | 610° C. | 620° C. |

FIG. 5 is comparative heating curves illustrating the heating curves of FIGS. 2 to 4 together. A1, A2, and A3 are heating curves on float glasses of 3 mm, 5 mm, and 8 mm, respectively. B1, B2, and B3 are heating curves on plate glasses of 3 mm, 5 mm, and 8 mm, respectively, having lead-free crystal ice attached thereto. C1, C2, and C3 are heating curves on plate glasses of 3 mm, 5 mm, and 8 mm, respectively, having lead crystal ice attached thereto.

As seen from FIGS. 2 to 5 and Tables 4 to 6, the inventor of the present invention confirmed that the heating time to reach the melting peak point temperature of crystal ice when the temperature of the plate glass inside the horizontal tempering furnace reaches 620° C., and the heating time of the float glass without the crystal ice has a relative ratio.

The plate glasses (B1, B2, and B3) attached with lead-free crystal ice had the heating time (by thickness) of about 10 to 15% longer than the heating time (by thickness) of the float glasses (A1, A2, and A3) as seen from the comparative heating curves in FIG. 5. Furthermore, the plate glasses (C1, C2, and C3) attached with lead crystal ice had the heating time (by thickness) of about 0 to 10% longer than the heating time (by thickness) of the float glasses (A1, A2, and A3), as also seen from FIG. 5.

It is already predicted that more thermal energy of that extent is required for melting the crystal ice attached to the surface of the plate glass compared with the thermal energy for heating the float glass. Thus, there is a big meaning in that the relative ratios with respect to the float glass can be accurately known through experiments.

In addition, the biggest difference between the lead crystal ice and the lead-free crystal ice is that the lead crystal ice includes a great amount of a lead (Pb) component and a cadmium (Cd) component unlike the lead-free crystal ice as mentioned above. Another difference is that the “time to reach the melting peak point temperature’ in heat-curing is different.

The inventor of the present invention conducted an experiment, and as a result, it was found that the time to reach the melting peak point temperature of the lead-free crystal ice is shorter than the time to reach the melting peak point temperature of the lead crystal ice. In the experiment, by having the temperature of the crystal ice in the set melting point temperature of crystal ice ranging 620 to 630° C., the time to reach the melting peak point temperature of the lead crystal ice when the solid crystal ice changes into liquid was measured to be about 30 seconds. On the other hand, the time to reach the melting peak point temperature of the lead-free crystal ice was measured to be about 15 seconds.

The information on the time to reach the melting peak point of the lead-free crystal ice and the lead crystal ice is usefully utilized in finding the melting peak point temperature.

Meanwhile, when the heating time measured between the lead-free crystal ice and the lead crystal ice was compared, the heating time for the lead-free crystal ice was preferably about 10 to 15% longer than the heating time for the lead crystal ice.

Through this experiment, it was confirmed that the lead-free crystal ice required about 10 to 15% longer heating time compared with the lead crystal ice. Further, the lead-free crystal ice required about 2% higher temperature compared with the lead crystal ice. Such information on the heating time and relative temperature control is usefully utilized in finding the melting peak point temperature of the corresponding crystal ice.

In addition, the correlation between the temperature inside the heating furnace and size of the horizontal tempering furnace, when the temperature of the plate glass itself is in the range of 620 to 630° C. after inserting the plate glass attached with crystal ice into the horizontal tempering furnace, was confirmed. When the horizontal tempering furnace is an electrically heated radiation furnace with the floor space (width×length) inside the heating furnace of 4 to 10 m², the temperature inside the heating furnace is 685 to 695° C. When the horizontal tempering furnace is an electrically heated radiation furnace with the floor space (width×length) inside the heating furnace of 10 to 18 m², the temperature inside the heating furnace is 695 to 705° C. The heights inside of the heating furnaces of the electrically heated radiation furnaces are almost the same without depending on the type of the furnace. The temperature inside the heating furnace of 685 to 705° C. may change a little by the improvement in the heating furnace performances or deterioration of the horizontal tempering furnace.

In the embodiment of the present invention, the heating temperature inside the horizontal tempering furnace at rapid heating for manufacturing a decorative plate glass is set such that the heating temperature is 685 to 695° C. in the case of an electrically heated radiation furnace with the floor space (width×length) inside the heating furnace of 4 to 10 m², and the heating temperature is 695 to 705° C. in the case of an electrically heated radiation furnace with the floor space (width×length) inside the heating furnace of 10 to 18 m².

When performing a quenching after taking out the plate glass melt-attached with crystal ice at the melting peak point temperature through rapid heating and transferring the plate glass to a cooling device of the horizontal tempering furnace, an optimal quenching state is obtained by controlling a quenching air pressure and a quenching time for each thickness of the plate glass.

When the plate glass has a thickness of 2 mm, quenching is performed by reducing 45 to 55% (preferably 50%) of the quenching air pressure and extending 15 to 25% (preferably 20%) of the quenching time from the cooling conditions set in each furnace for cooling the float glass. Thereafter, according to the set cooling conditions in each furnace, the cooling was performed to obtain an optimal decorative plate glass.

When the plate glasses have a thickness of 3 mm and 3.2 mm, quenching is performed by reducing 35 to 45% (preferably 40%) of the quenching air pressure and extending 30 to 40% (preferably 35%) of the quenching time from the cooling conditions set in each furnace for toughening the float glass to obtain an optimal decorative plate glass.

When the plate glasses have a thickness of 4 mm and 5 mm, quenching is performed by reducing 25 to 35% (preferably 30%) of the quenching air pressure and extending 15 to 25% (preferably 20%) of the quenching time from the cooling conditions set in each furnace for toughening the float glass to obtain an optimal decorative plate glass.

When the plate glasses have a thickness of 6 mm, 8 mm, 10 mm, and 12 mm, quenching is performed with the same the cooling conditions (i.e., quenching air pressure, quenching time, cooling time, etc.) set in each furnace for toughening the float glass to obtain an optimal decorative plate glass.

The same cooling conditions for the float glass are applied to the cooling conditions for the plate glass when the plate glass has a thickness of 6 mm or more. Thus, the inventor of the present invention found that when the thickness of the plate glass is thick enough to ignore a melt-attached thickness of crystal ice of about 0.7 to 0.9 mm formed on the body plate glass, the same cooling conditions for toughening the body plate glass may be used in the method of cooling the decorative plate glass.

As mentioned in the experiments above, in manufacturing the decorative plate glass by the rapid heating and quenching using the horizontal tempering furnace after attaching crystal ice onto the surface of the plate glass, first, the following crystal ice according to the embodiment of the present invention was prepared. That is, the crystal ice was prepared by regulating the constituent components of the crystal such that the melting point temperature of crystal ice is formed within the set range (620 to 630° C.) of the melting point temperature of the crystal ice defined as a toughening temperature of a pane core of 620° C. to 10° C. above.

The prepared crystal ice of the present invention was attached onto the surface of the plate glass, and then rapidly heated with a heating temperature of 685 to 705° C. inside the horizontal tempering furnace corresponding to the melting point temperature of the crystal ice in the range of 620 to 630° C. in the horizontal tempering furnace. The rapid heating is performed by controlling the heating time using a first control factor, which is readily set with respect to the toughening temperature heating time of a float glass.

The first control factor determines a heating time such that the heating time is 0 to 15% longer than the heating time of the toughening temperature of the float glass. When the crystal ice is lead-free crystal ice, the heating time is determined to be 10 to 15% longer than the heating time of the toughening temperature of the float glass. When the crystal ice is lead crystal ice, the heating time is determined to be 0 to 10% longer than the heating time of the toughening temperature of the float glass.

After the rapid heating, the plate glass melt-attached with crystal ice is quenched by controlling the cooling conditions using a second control factor, which is readily set with respect to the cooling conditions for toughening a float glass, thereby manufacturing a decorative plate glass. The second control factor determines the cooling conditions by controlling the quenching air pressure and quenching time depending on the thickness of the plate glass.

The first control factor for rapid heating, the second control factor for quenching, and the other above-mentioned control factors are reflected to a control part and applied. Thus, a technician can quickly take out the plate glass melt-attached with crystal ice from the heating furnace at the melting peak point temperature of the crystal ice without largely depending on one's experience. Further, the plate glass melt-attached with crystal ice inserted into the cooling device can be subjected to quenching in an optimal state in manufacturing a decorative plate glass.

The inventor of the present invention reflected these experiment results, and applied them to an actual production process as an example. As a result, the inventor of the present invention obtained a very good decorative plate glass.

### MODE FOR THE INVENTION

### Preparation Example 1

Lead-free crystal ice (average particle size of 0.2 to 1.0 mm), which is melted at the melting point temperature in the range of 620 to 630° C., that is, the temperature inside the heating furnace of 685 to 710° C., was used. Onto a plate glass having a thickness of about 2 mm, a well-known adhesive agent was applied to express a design, and the crystal ice was sprayed thereon. Then, the plate glass was put through a drying furnace to dry the adhesive agent completely.

Thereafter, the plate glass was inserted into an electrically heated radiation furnace having a size of 2.1 m×4.5 m, and heat cured at a heating temperature of 705° C. inside the horizontal tempering furnace for about 80 to 90 seconds. Then, the cured plate glass was quickly transferred to a cooling device of the horizontal tempering furnace where the plate glass was quenched with cold air having an air pressure of about 18,000 to 22,000 Pq for about 30 seconds. Then, a cooling was performed for about 50 to 60 seconds. Here, the pressure unit ‘Pq’ is a standard gas meter, which is a value (%) of 98 Pa converted by 0.1%.

In the above preparation experiment, the crystal ice melt-attached to the plate glass had the melting peak point temperature, and the body plate glass had increased strength.

### Preparation Example 2

Lead-free crystal ice (average particle size of 0.2 to 1.0 mm), which is melted at the melting point temperature in the range of 620 to 630° C., that is, the temperature inside the heating furnace of 685 to 710° C., was used. Onto a plate glass having a thickness of about 3 mm, a well-known adhesive agent was applied to express a design, and the crystal ice was sprayed thereon.

Thereafter, the plate glass was inserted into an electrically heated radiation furnace having a size of 2.1 m×4.5 m, and heat cured at a heating temperature of 700° C. inside the horizontal tempering furnace for about 140 seconds. Then, the cured plate glass was quickly transferred to a cooling device of the horizontal tempering furnace where the plate glass was quenched by an air blowing method using cold air having an air pressure of about 10,000 to 15,000 Pq for about 40 seconds. Then, a cooling was performed for about 80 to 100 seconds.

In the above preparation experiment, the crystal ice melt-attached to the plate glass had the melting peak point temperature, and the body plate glass had increased strength. However, the body plate glass did not become a toughened safety glass.

### Preparation Example 3

Lead-free crystal ice (average particle size of 0.2 to 1.0 mm), which is melted at the melting point temperature in the range of 620 to 630° C., that is, the temperature inside the heating furnace of 685 to 710° C., was used. Onto a plate glass having a thickness of about 4 mm, a well-known adhesive agent was applied to express a design, and the crystal ice was sprayed thereon.

Thereafter, the plate glass was inserted into an electrically heated radiation furnace having a size of 2.1 m×4.5 m, and heat cured at a heating temperature of 700° C. inside the horizontal tempering furnace for about 180 seconds. Then, the cured plate glass was quickly transferred to a cooling device of the horizontal tempering furnace where the plate glass was quenched by an air blowing method using cold air having an air pressure of about 4000 to 4600 Pq for about 50 seconds. Then, a cooling was performed for about 100 to 120 seconds.

In the above preparation experiment, the crystal ice melt-attached to the plate glass had the melting peak point temperature, and the body plate glass had increased strength. In addition, when the quenching air pressure is elevated to about 6000 to 6500 Pq in the above process, the body plate glass became a toughened safety glass.

### Preparation Example 4

Lead-free crystal ice (average particle size of 0.2 to 1.0 mm), which is melted at the melting point temperature in the range of 620 to 630° C., that is, the temperature inside the heating furnace of 685 to 710° C., was used. Onto a plate glass having a thickness of about 5 mm, a well-known adhesive agent was applied to express a design, and the crystal ice was sprayed thereon.

Thereafter, the plate glass was inserted into an electrically heated radiation furnace having a size of 2.1 m×4.5 m, and heat cured at a heating temperature of 700° C. inside the horizontal tempering furnace for about 225 seconds. Then, the cured plate glass was quickly transferred to a cooling device of the horizontal tempering furnace where the plate glass was quenched by an air blowing method using cold air having an air pressure of about 2300 to 2500 Pq for about 80 to 90 seconds. Then, a cooling was performed for about 100 to 120 seconds.

In the above preparation experiment, the crystal ice melt-attached to the plate glass had the melting peak point temperature, and the body plate glass became a toughened safety glass.

### Preparation Example 5

Lead-free crystal ice (average particle size of 0.2 to 1.0 mm), which is melted at the melting point temperature in the range of 620 to 630° C., that is, the temperature inside the heating furnace of 685 to 710° C., was used. Onto a plate glass having a thickness of about 6 mm, a well-known adhesive agent was applied to express a design, and the crystal ice was sprayed thereon.

Thereafter, the plate glass was inserted into an electrically heated radiation furnace having a size of 1.8 m×2.4 m, and heat cured at a heating temperature of 695° C. inside the horizontal tempering furnace for about 270 seconds. Then, the cured plate glass was quickly transferred to a cooling device of the horizontal tempering furnace where the plate glass was quenched by an air blowing method using cold air having an air pressure of about 1200 to 1500 Pq for about 120 seconds. Then, a cooling was performed for about 130 to 150 seconds.

In the above preparation experiment, the crystal ice melt-attached to the plate glass had the melting peak point temperature, and the strength of the body plate glass became practically the same as a toughened safety glass.

### Preparation Examples 6 to 8

Onto plate glasses having a thickness of about 8 mm, 10 mm, and 12 mm, a well-known adhesive agent was applied to express a design, and lead-free crystal ice, which is melted at the melting point temperature in the range of 620 to 630° C., that is, the temperature inside the heating furnace of 685 to 710° C., was sprayed thereon. The lead-free crystal ice (average particle size of 0.2 to 1.0 mm), which is melted at the melting point temperature in the range of 620 to 630° C., that is, the temperature inside the heating furnace of 685 to 710° C., was used.

Thereafter, the plate glasses were inserted into an electrically heated radiation furnace having a size of 1.8 m×2.4 m. And, the plate glasses of 8 mm and 10 mm were heat cured at a heating temperature of 690° C., and the plate glass of 12 mm was heat cured at a heating temperature of 685° C. inside the horizontal tempering furnace for about 360, 450, and 540 seconds, respectively. Then, the cured plate glasses were quickly transferred to a cooling device of the horizontal tempering furnace where the plate glasses were cooled in the same cooling conditions for toughening the float glass.

In the above preparation experiment, the crystal ice melt-attached to the plate glasses had the melting peak point temperature, and the body plate glasses became toughened safety glasses.

In the present invention, an electrically heated radiation furnace was mainly utilized in describing Examples. However, a gas heated convection furnace or a forced convection-heating furnace may also be utilized, as long as the airflow that circulate inside the heating furnace is prevented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention can be applied to manufacturing a decorative plate glass.

1. A method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising:
providing crystal ice whose constituent components are regulated such that a melting point temperature of the crystal ice is formed within the set range of the melting point temperature of the crystal ice defined as a toughening temperature of a pane core to 10° C. above;
attaching the crystal ice onto a surface of the plate glass, and rapidly heating the plate glass at a heating temperature inside the horizontal tempering furnace that corresponds to the set range of the melting point temperature of the crystal ice in the horizontal tempering furnace, wherein the rapid heating is performed by controlling a heating time using a first control factor which lengthens a heating time with respect to a heating time to the toughening temperature of a float glass; and
rapidly cooling the crystal-ice-melt-attached plate glass by controlling cooling conditions using a second control factor which reduces the quenching air pressure and lengthens the quenching time for the plate glass of thickness 2 to 6 mm and is the same condition of the quenching air pressure and the quenching time for the plate glass of thickness 6 mm or more corresponding to the cooling conditions for toughening the float glass after the rapid heating.

2. The method according to claim 1, wherein the crystal ice has a melting point temperature set in a range of 620 to 630° C.

3. The method according to claim 2, wherein the set range of the melting point temperature of the crystal ice corresponds to a temperature of 685 to 710° C., which is the temperature inside a heating furnace of an electrically heated radiation furnace.

4. The method according to claim 1, wherein the first control factor determines a heating time such that the heating time is 0 to 15% longer than the heating time of the toughening temperature of the float glass.

5. The method according to claim 4, wherein the first control factor determines a heating time such that when the crystal ice is lead-free crystal ice the heating time is determined to be 10 to 15% longer than the heating time of the toughening temperature of the float glass, and when the crystal ice is lead crystal ice the heating time is determined to be 0 to 10% longer than the heating time of the toughening temperature of the float glass.

6. The method according to claim 1, wherein the heating temperature inside the horizontal tempering furnace is 685 to 710° C.

7. The method according to claim 4, wherein the first control factor is obtained through trials by installing a thermometer that measures a temperature of the plate glass itself inside the heating furnace of the horizontal tempering furnace.

8. A method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising:
providing crystal ice whose constituent components are regulated such that a melting point temperature of the crystal ice is formed within the set range of the melting point temperature of the crystal ice defined as a toughening temperature of a pane core to 10° C. above;
attaching the crystal ice onto a surface of the plate glass, and rapidly heating the plate glass at a heating temperature inside the horizontal tempering furnace that corresponds to the set range of the melting point temperature of the crystal ice in the horizontal tempering furnace, wherein the rapid heating is performed by controlling a heating time using a temperature which is measured by a thermometer capable of directly measuring a temperature of the plate glass itself to be put into the horizontal tempering furnace; and
rapidly cooling the crystal-ice-melt-attached plate glass by controlling cooling conditions to reduce the quenching air pressure and lengthen the quenching time for the plate glass of thickness 2 to 6 mm and to be the same condition of the quenching air pressure and the quenching time for the plate glass of thickness 6 mm or more corresponding to the cooling conditions for toughening the float glass after the rapid heating.

9. A method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising:
providing lead-free crystal ice whose constituent components are regulated such that a melting point temperature of the lead-free crystal ice is formed within the set range of the melting point temperature of the lead-free crystal ice defined as a toughening temperature of a pane core to 10° C. above;
attaching the lead-free crystal ice onto a surface of the plate glass, and rapidly heating the plate glass at a heating temperature inside the horizontal tempering furnace that corresponds to the set range of the melting point temperature of the lead-free crystal ice in the horizontal tempering furnace, wherein the rapid heating is performed by controlling a heating time such that the heating time is 10 to 15% longer than a heating time to the toughening temperature of a float glass; and
rapidly cooling the lead-free crystal-ice-melt-attached plate glass by controlling cooling conditions using a control factor which reduces the quenching air pressure and lengthens the quenching time for the plate glass of thickness 2 to 6 mm and is the same condition of the quenching air pressure and the quenching time for the plate glass of thickness 6 mm or more corresponding to the cooling conditions for toughening the float glass after the rapid heating.

10. The method according to claim 9, wherein the lead-free crystal ice has a melting point temperature set in a range of 620 to 630° C.

11. The method according to claim 10, wherein the set range of the melting point temperature of the lead-free crystal ice corresponds to a temperature of 685 to 710° C., which is the temperature inside a heating furnace of an electrically heated radiation furnace.

12. The method according to claim 10, wherein the lead-free crystal ice has constituent components consisting of Na₂O, ZnO, B₂O₃, SiO₂, TiO₂, ZrO₂, Al₂O₃, K₂O, Mg, CaCo₃, Nd, and F.

13. The method according to claim 10, wherein the lead-free crystal ice has constituent components consisting of Na₂O, ZnO, B₂O₃, SiO₂, CaO, Al₂O₃, BaO, SrO, Li₂O₃, Fe₂O, and ZrO₂.

14. The method according to claim 10, wherein the lead-free crystal ice has constituent components consisting of Na₂O, ZnO, B₂O₃, SiO₂, CaO, Al₂O₃, BaO, Li₂O₃, and SrO.

15. The method according to claim 12, wherein among the constituent components of the lead-free crystal ice, the composition ratio of Na₂O and B₂O₃ components are regulated to form a melting point temperature of the lead-free crystal ice in a set range of 620 to 630° C.

16. The method according to claim 9, wherein the heating temperature inside of the horizontal tempering furnace is 685 to 710° C.

17. The method according to claim 16, wherein the heating temperature inside the horizontal tempering furnace is 685 to 695° C. when a floor space (width×length) inside the heating furnace of the electrically heated radiation furnace is 4 to 10 m², and 695 to 705° C. when a floor space (width×length) inside the heating furnace of the electrically heated radiation furnace is 10 to 18 m².

18. (canceled)

19. The method according to claim 9, wherein the control factor, when a plate glass thickness is 2 mm performs quenching by reducing 45 to 55% of the quenching air pressure and extending 15 to 25% of the quenching time from the cooling conditions set on each furnace for cooling a float glass, and then performing a general cooling in the cooling conditions set on each furnace.

20. The method according to claim 9, wherein the control factor, when a plate glass thickness is 3 mm and 3.2 mm performs quenching by reducing 35 to 45% and 30 to 40%, respectively, of the quenching air pressure and extending 15 to 25%, respectively, of the quenching time from the cooling conditions set on each furnace for toughening a float glass.

21. The method according to claim 9, wherein the control factor, when a plate glass thickness is 4 mm and 5 mm performs quenching by reducing 25 to 35% and 15 to 25%, respectively, of the quenching air pressure and extending 15 to 25%, respectively, of the quenching time from the cooling conditions set on each furnace for toughening a float glass.

22. (canceled)

23. A method for manufacturing a decorative plate glass using a horizontal tempering furnace comprising, attaching crystal ice onto a surface of a plate glass, and subjecting the plate glass to a rapid heating and quenching treatment using a horizontal tempering furnace, the method further comprising:
providing lead crystal ice whose constituent components are regulated such that a melting point temperature of the lead crystal ice is formed within the set range of the melting point temperature of the lead crystal ice defined as a toughening temperature of a pane core to 10° C. above;
attaching the lead crystal ice onto a surface of the plate glass, and rapidly heating the plate glass at a heating temperature inside the horizontal tempering furnace that corresponds to the set range of the melting point temperature of the lead crystal ice in the horizontal tempering furnace, wherein the rapid heating is performed by controlling a heating time such that the heating time is 0 to 10% longer than a heating time to the toughening temperature of a float glass; and
rapidly cooling the lead-free crystal-ice-melt-attached plate glass by controlling cooling conditions using a control factor which reduces the quenching air pressure and lengthens the quenching time for the plate glass of thickness 2 to 6 mm and is the same condition of the quenching air pressure and the quenching time for the plate glass of thickness 6 mm or more corresponding to the cooling conditions for toughening the float glass after the rapid heating.

24. The method according to claim 23, wherein the lead crystal ice has constituent components consisting of SiO₂, B₂O₃, Na₂O, ZnO, PbO, Cd, K₂O, Fe₂O₃, CaO, and Al₂O₃, and among the constituent components, the composition ratio of PbO is controlled such that the lead crystal ice has a melting point temperature set in a range of 620 to 630° C.
